(19) United States
(12) Patent Application Publication
(10) Pub. No.: US 2012/0324056 A1
(43) Pub. Date: Dec. 20, 2012

(54) METHOD AND APPARATUS FOR HITLESS REDUNDANCY IN DATA STREAMING

(76) Inventor: David Miles, Mountain View, CA (US)

(21) Appl. No.: 13/163,822

(22) Filed: Jun. 20, 2011

(51) Int. Cl. G06F 15/16

(52) U.S. Cl. 709/219

(57) ABSTRACT

A resilient data transfer capability is provided. The resilient data transfer capability is provided in a system including active and backup servers configured for supporting a TCP connection to a client. The resilient data transfer capability provides for continuation of the TCP connection with the client, using the backup server, upon failure of the active server, thereby enabling continuation of a TCP data transfer to the client via the TCP connection when the active server from which the client is downloading the data fails during the middle of the TCP data transfer. In this manner, the resilient data transfer capability enables the backup server to assume responsibility for the TCP connection from the active server without causing any associated problems (e.g., without resetting the TCP connection or causing any client side errors).

### TECHNICAL FIELD

The invention relates generally to communication networks and, more specifically but not exclusively, to providing resiliency in streaming of data via communication networks.

### BACKGROUND

The Transmission Control Protocol (TCP) provides ordered, reliable delivery of a stream of bytes from a program on a sending computer to a program on a receiving computer, providing a point-to-point channel for applications that require reliable communications. For example, TCP is used by many major Internet applications, such as the World Wide Web, e-mail, and file transfers. In these and other applications, TCP is often used to transfer information from a server to a client. Disadvantageously, however, failure of a server during an active TCP session may cause various problems.

### SUMMARY

Various deficiencies in the prior art are addressed by embodiments for providing a resilient data transfer capability for a Transmission Control Protocol (TCP) connection.

In one embodiment, an apparatus is provided for maintaining a transfer of a data object to a client via a TCP connection using a backup server when an active server fails. The apparatus includes a processor and a memory, where the processor is configured to perform functions for maintaining the transfer of the data object to the client via the TCP connection using the backup server when the active server fails. The processor is configured to receive, at the backup server, TCP connection information associated with the TCP connection between the active server and the client and data object transfer information associated with a data object transfer supported using the TCP connection between the active server and the client. The processor is configured to, when the active server fails, receive, at the backup server, a TCP acknowledgment message of the client comprising a current TCP sequence number for the data object transfer via the TCP connection between the active server and the client, and continue the data object transfer to the client via the TCP connection using the TCP connection information, the data object transfer information, and the current TCP sequence number.

In one embodiment, a method is provided for maintaining a transfer of a data object to a client via a TCP connection using a backup server when an active server fails. The method includes steps for maintaining the transfer of the data object to the client via the TCP connection using the backup server when the active server fails. At the backup server, information is received, where the information includes TCP connection information associated with the TCP connection between the active server and the client and data object transfer information associated with a data object transfer supported using the TCP connection between the active server and the client. When the active server fails, the backup server receives a TCP acknowledgment message of the client including a current TCP sequence number for the data object transfer via the TCP connection between the active server and the client, and continues the data object transfer to the client via the TCP connection using the TCP connection information, the data object transfer information, and the current TCP sequence number.

In one embodiment, an apparatus is provided for maintaining a transfer of a data object to a client via a TCP connection using a backup server when an active server fails. The apparatus includes a processor and a memory, where the processor is configured to perform functions for maintaining the transfer of the data object to the client via the TCP connection using the backup server when the active server fails. The processor is configured to receive, at the backup server, a TCP acknowledgment message of the client comprising a current TCP sequence number for the data object transfer via the TCP connection between the active server and the client. The processor is configured to determine, based on the current TCP sequence number and a TCP sequence number representing a first portion of the data object transferred from the active server to the client via the TCP connection, a next portion of the data object to be transferred from the backup server to the client. The processor is configured to propagate the next portion of the data object from the backup server toward the client via the TCP connection.

In one embodiment, a method is provided for maintaining a transfer of a data object to a client via a TCP connection using a backup server when an active server fails. The method includes steps for maintaining the transfer of the data object to the client via the TCP connection using the backup server when the active server fails. At the backup server, a TCP acknowledgment message of the client, including a current TCP sequence number for the data object transfer via the TCP connection between the active server and the client, is received. Based on the current TCP sequence number and a TCP sequence number representing a first portion of the data object transferred from the active server to the client via the TCP connection, a next portion of the data object to be transferred from the backup server to the client is determined. The next portion of the data object is propagated from the backup server toward the client via the TCP connection.

### BRIEF DESCRIPTION OF THE DRAWINGS

The teachings herein can be readily understood by considering the following detailed description in conjunction with the accompanying drawings, in which:

FIG. 1 depicts an exemplary communication system illustrating use of active and backup servers to support a TCP connection configured to transfer data to a client;

FIG. 2 depicts an exemplary process by which the communication system of FIG. 1 transfers the TCP connection from the active server to the backup server while maintaining an active data object transfer via the TCP connection;

FIG. 3 depicts a method according to one embodiment of the resilient data transfer capability; and

FIG. 4 depicts a high-level block diagram of a computer suitable for use in performing the functions described herein.

To facilitate understanding, identical reference numerals have been used, where possible, to designate identical elements that are common to the figures.

### DETAILED DESCRIPTION OF ILLUSTRATIVE EMBODIMENTS

A resilient data transfer capability is depicted and described herein, although it is noted that various other capabilities also may be depicted and described herein.

In at least some embodiments, in a system including active and backup servers configured for supporting a TCP connection to a client, the resilient data transfer capability provides for continuation of the TCP connection with the client, using the backup server, upon failure of the active server. As a result, the resilient data transfer capability, by providing for continuation of the TCP connection to the client, provides for continuation of an active TCP data transfer to the client via the TCP connection when the active server from which the data is being transferred to the client fails during the data transfer. In this manner, the resilient data transfer capability enables the backup server to assume responsibility for the TCP connection from the active server while maintaining the active data transfer, without causing any associated problems (e.g., without resetting the TCP connection or causing any client side errors).

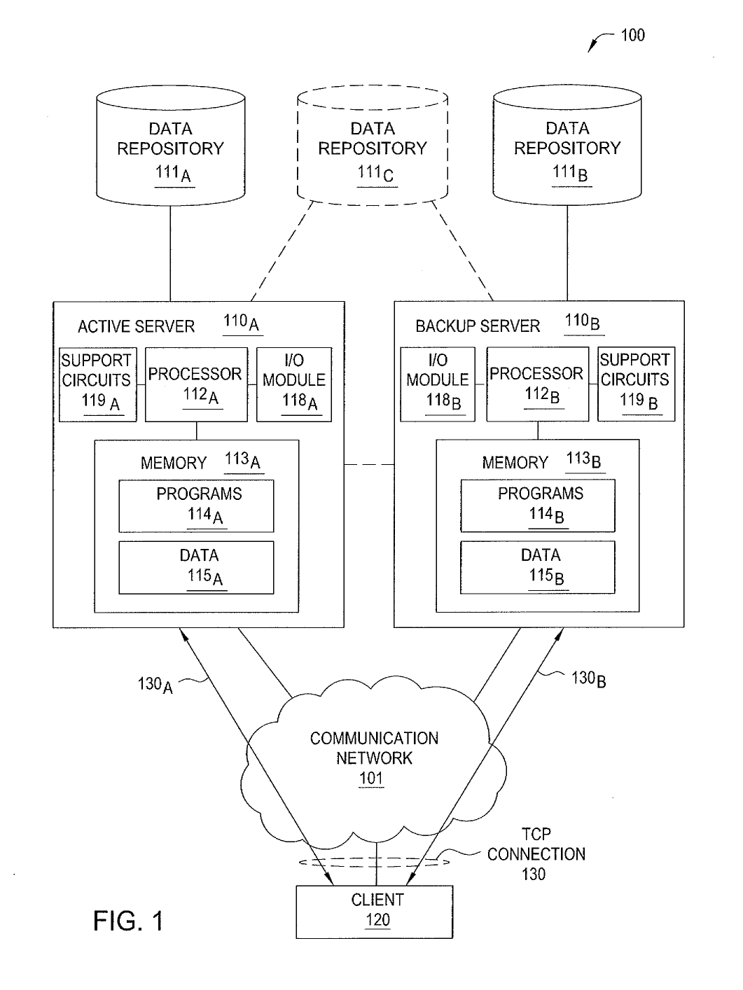

FIG. 1 depicts an exemplary communication system illustrating use of active and backup servers to support a TCP connection configured to transfer data to a client.

As depicted in FIG. 1, exemplary communication system 100 includes a communication network 101, a pair of servers including an active server 110_{A} and a backup server 110_{B} (collectively, servers 110), and a client 120.

The communication network 101 may be any communication network configured for supporting TCP-based communications.

The servers 110 each are configured for transferring data to the client 120 using TCP (illustratively, via TCP connection 130). The servers 110 may include any types of servers configured for communicating using TCP (e.g., Hypertext Transfer Protocol (HTTP) servers, File Transfer Protocol (FTP) servers, and the like).

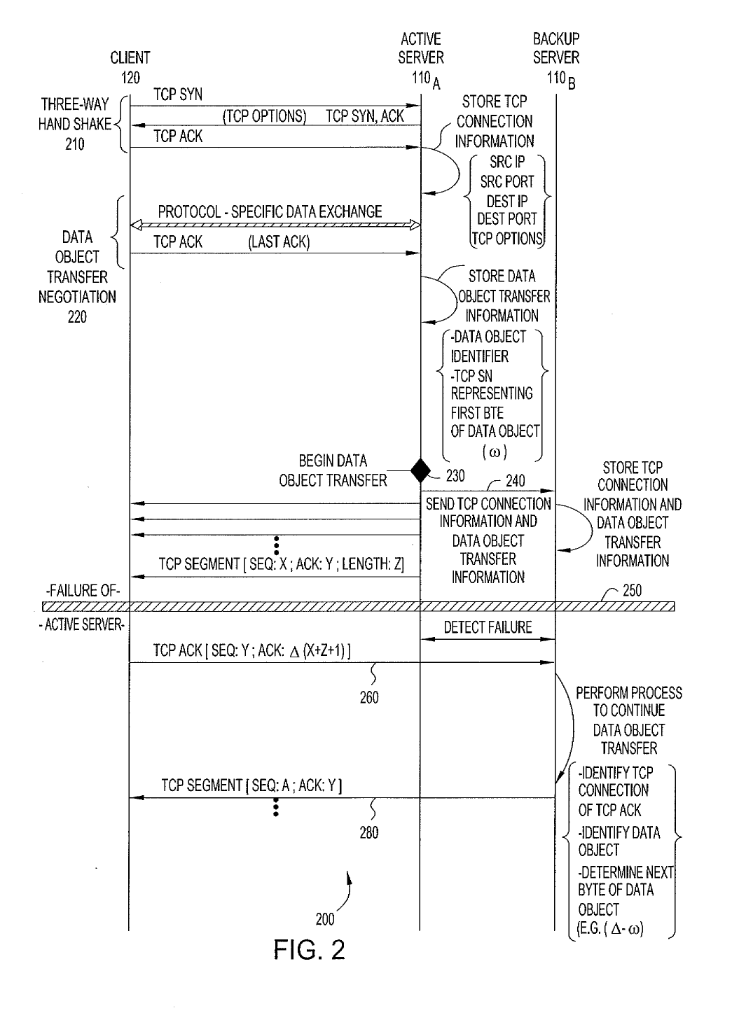

The active server 110_{A} is configured to provide various functions of the resilient data transfer capability, many of which are depicted and described herein with respect to FIG. 2. In one embodiment, for example, as depicted in FIG. 1, active server 110_{A} includes a processor 112_{A}, a memory 113_{A}, an input-output (I/O) module 118_{A}, and support circuits (SCs) 119_{A}, where the memory 113_{A}, I/O module 118_{A}, and SCs 119_{A} each communicate with processor 112_{A}. The memory 113_{A} stores programs 114_{A}, which may include one or more programs configured to provide various functions of the resilient data transfer capability. The memory 113_{A} also stores data 115_{A}, which may include data transfer resiliency information that is configured for use in providing various functions of the resilient data transfer capability (e.g., TCP connection information for the TCP connection 130, data object transfer information associated with one or more data objects transfers being supported via the TCP connection 130, and the like, which are described in additional detail with respect to FIG. 2). Although primarily depicted and described as having specific elements arranged in a specific manner, it is noted that the active server 110_{A} may be implemented in any manner suitable for providing various functions of the resilient data transfer capability.

The backup server 110_{B} is configured to provide various functions of the resilient data transfer capability, many of which are depicted and described herein with respect to FIG. 2. In one embodiment, for example, as depicted in FIG. 1, backup server 110_{B} includes a processor 112_{B}, a memory 113_{B}, an input-output (I/O) module 118_{B}, and support circuits (SCs) 119_{B}, where the memory 113_{B}, I/O module 118_{B}, and SCs 119_{B} each communicate with processor 112_{B}. The memory 113_{B} stores programs 114_{B}, which may include one or more programs configured to provide various functions of the resilient data transfer capability. The memory 113_{B} also stores data 115_{B}, which may include data transfer resiliency information that is configured for use in providing various functions of the resilient data transfer capability (e.g., TCP connection information for the TCP connection 130, data object transfer information associated with one or more data objects transfers being supported via the TCP connection 130, and the like, which are described in additional detail with respect to FIG. 2). Although primarily depicted and described as having specific elements arranged in a specific manner, it is noted that the active server 110_{A} may be implemented in any manner suitable for providing various functions of the resilient data transfer capability. The client 120 may be any client device configured for communication using TCP (e.g., a desktop computer, a laptop computer, a tablet computer, a set top box (STB), a smart phone, and the like). The client 120 includes a protocol stack including support for communications using TCP. The client 120 includes one or more applications via which the client may request a data object from the active server 110_{A} and/or via which a data object may be handled when received by client 120 (e.g., a web browser application, a media player application, and the like). It is noted that various embodiments of the resilient data transfer capability may be provided without requiring any modification to the client 120, thereby enabling use of various embodiments of the resilient data transfer capability by the existing base of client devices configured for communication using TCP.

As depicted in FIG. 1, a TCP connection 130 is established for use in transferring data from the servers 110 to client 120. The TCP connection 130 is initially established between active server 110_{A} and client 120, and active server 110_{A} transfers data to client 120 using the TCP connection 130 until active server 110_{A} fails, at which time the TCP connection 130 is transitioned from active server 110_{A} to backup server 110_{B} in a manner for maintaining the TCP connection 130, and the associated data transfer provided via the TCP connection, during the transition. The two phases of TCP connection 130 are denoted in FIG. 1 as TCP connection 130_{A} (i.e., when the TCP connection is active between the active server 110_{A} and client 120) and TCP connection 130_{B} (i.e., when the TCP connection is active between the backup server 110_{B} and client 120).

The active server 110_{A} and backup server 110_{B} each have access to a data object to be streamed via the TCP connection 130. The data object streamed to the client 120 via the TCP connection 130 is the same data object, which may be one copy of the data object accessed by both of the servers 110 or two copies of the data object accessed by respective servers 110. The data object streamed to the client 120 via the TCP connection 130 may include any type(s) of data suitable for being streamed using TCP. For example, the data may include audio, video, multimedia, text, software, and the like, as well as various combinations thereof. For example, the data object may be a song, an album, a television program, a movie, a software upgrade, and the like.

The active server 110_{A} and backup server 110_{B} may access the data object, to be streamed via TCP connection 130, in any suitable manner. In one embodiment, the active and backup servers 110_{A} and 110_{B} have data repositories 111_{A} and 111 _{B} associated therewith, respectively, which may be local to and/or remote from servers 110. In one embodiment, the active and backup servers 110_{A} and 110_{B} access a common data repository 111_{C}. The data repositories 111_{A}, 111_{B}, and 111_{C} may be referred to collectively as data repositories 111. It is noted that, within the context of providing the resilient data transfer capability, the active server 110_{A} and backup server 110_{B} each have access to the data object to be streamed via TCP connection 130, irrespective of the number(s) and/or location(s) of the data repository(s) from which the data object may be obtained by the active server 110_{A} and the backup server 110_{B}.

The active server 110_{A} and backup server 110_{B} cooperate to provide the resilient data transfer capability, by which transfer of a data object to client 120 via TCP connection 130 is initially provided via TCP connection 130_{A} while active server 110_{A} is active and is then switched to being provided via TCP connection 130_{B} when active server 110_{A} fails. A description of a process by which transfer of a data object to client 120 via TCP connection 130 is maintained by backup server 110_{B} after failure of active server 110_{A} is provided with respect to FIG. 2.

FIG. 2 depicts an exemplary process by which the exemplary communication system of FIG. 1 transfers the TCP connection from the active server to the backup server while maintaining an active data object transfer via the TCP connection. In general, the operation of TCP will be understood by one skilled in the art. However, certain features of TCP are described herein for purposes of better explaining various functions of the resilient data transfer capability.

As depicted at step 210 of FIG. 2, the TCP connection 130 is initially established between active server 110_{A} and client 120 (illustratively, denoted as TCP connection 130_{A}) via the communication network 101. The TCP connection 130_{A} is established using a three-way handshaking procedure. In general, the three-way handshaking procedure of TCP includes the following sequence of steps: (1) the initiating side (illustratively, client 120) sends a segment with the SYN flag set and a proposed initial sequence number (e.g., X) in the sequence number field, (2) on receiving the segment from the initiating side, the receiving side (illustratively, active server 110_{A}) returns a segment with both the SYN and ACK flags set, a proposed sequence number (e.g., Y) for the reverse direction in the sequence number field, and an acknowledgement field including a value of X+1; and (3) on receiving the segment from the receiving side, the initiating side makes a note of Y and returns a segment with the ACK flag set and an acknowledgement field including a value of Y+1. At this point, both the client and the server have received acknowledgment of the TCP connection. During the establishment of the TCP connection 130_{A}, the active server 110_{A} determines TCP connection information associated with the TCP connection 130_{A}. In general, TCP connection information for a TCP connection typically includes: (1) source IP address, (2) source port, (3) destination IP address, (4) destination port, and (5) TCP options information. For example, the TCP connection information for TCP connection 130_{A} may include: (1) IP address of active server 110_{A}, (2) source port of active server 110_{A}, (3) IP address of client 120, (4) source port of client 120, and (5) TCP options. The active server 110_{A} stores the TCP connection information for enabling transfer of the TCP connection information to the backup server 110_{B}.

As depicted at step 220 of FIG. 2, following establishment of the TCP connection 130_{A}, a data object transfer negotiation is performed between the active server 110_{A} and the client 120, for negotiating details of a transfer of a data object from active server 110_{A} to client 120 via TCP connection 130_{A}.

The data object transfer negotiation includes a protocol-specific data exchange that is performed between active server 110_{A} and client 120.

The active server 110_{A}, during the protocol-specific data exchange, receives a data object request from the client 120. For example, in the case of HTTP, the client 120 may send an HTTP GET to the active server 110_{A} via the TCP connection 130_{A} and receive an associated HTTP response from the active server 110_{A}. For example, in the case of FTP, the client 120 may initiate a request for transfer of a file. The data object request of the client 120 includes an identifier of the requested data object. The data object identifier may be any suitable identifier (e.g., a unique data object name or number, a Uniform Resource Locator (URL) or other similar identifier of the data object, a unique object hash of the data object, and the like).

The active server 110_{A}, during the protocol-specific data exchange, determines a TCP Sequence Number representing a first byte of the data object transferred via the TCP connection 130_{A} (denoted herein as ω).

In this manner, active server 110_{A}, during the protocol-specific data exchange, determines data object transfer information associated with the data object transfer to be performed between active server 110_{A} and client 120 via TCP connection 130_{A}. The data object transfer information includes the data object identifier and the TCP Sequence Number representing a first byte of the data object, which are described above. The data object transfer information also may include other information associated with transfer of the data object via the TCP connection 130_{A}.

The active server 110_{A} stores the data object transfer information such that the data object transfer information is associated with the TCP connection information stored by the active server 110_{A} for the TCP connection 130_{A}.

As depicted at step 230 of FIG. 2, the active server 110_{A} begins to transfer the data object to client 120 via TCP connection 130_{A}.

In general, TCP provides ordered, reliable delivery of a stream of data from a program on a sending computer to a program on a receiving computer. On the sending side, TCP accepts data from a data stream, segments the data into data segments, and adds a TCP header to each data segment to form thereby TCP segments. The TCP segments may then be encapsulated into Internet Protocol (IP) packets (e.g., via addition of an IP header including fields such as destination IP address and the like) for routing via a network. In this sense, while IP handles the actual delivery of the data from the source to the destination via the communication network, TCP handles tracking of the individual units of data transmission, i.e., the data segments that the data object is divided into for efficient routing through the communication network. On the receiving side, when the client program on the receiving computer receives the IP packets, the TCP segments are extracted from the IP packets, and the TCP layer reassembles the data segments and ensures that the data segments are correctly ordered and error free as the data segments are provided to the application on the receiving computer.

In general, the format and use of TCP segments for providing ordered, reliable delivery of data will be understood by one skilled in the art. A TCP segment includes a TCP segment header and a TCP data section. The TCP segment header includes ten fields as well as an optional extension field typically referred to as an Options field. The ten fields of the TCP segment header include: (1) source port, (2) destination port, (3) sequence number, (4) acknowledgment number, (5) data offset, (6) reserved, (7) flags, (8) window size, (9) checksum, and (10) urgent pointer. With respect to the sequence number field, it is noted that (a) if the SYN flag is set, the value of the sequence number field is the initial sequence number (where the sequence number of the first data byte transported via the TCP connection is the initial sequence number plus one) and (b) if the SYN flag is clear, the value of the sequence number field is the accumulated sequence number of the first data byte of this TCP segment for the current session. With respect to the acknowledgment number field, it is noted that, with the exception of the first ACK sent by the sender and the receiver, if the ACK flag is set then the value of the acknowledgment number field is the next sequence number that the receiver is expecting (i.e., this acknowledges receipt by the receiver of all prior bytes (if any) sent from the sender to the receiver). The TCP data section follows the TCP segment header, and includes the payload data carried for the application.

The active server 110_{A}, upon establishment of TCP connection 130_{A} and completion of the data object transfer negotiation, begins propagating the data object to client 120 using the TCP connection 130_{A}. As indicated above, the active server 110_{A} may retrieve the data object from a data repository accessible only to the active server 110_{A} (illustratively, data repository 111_{A}) or from a data repository accessible to both the active and backup servers 110 (illustratively, data repository 111 _{C}). As noted above, the data object is segmented into segments for transmission from active server 110_{A} to client 120 via TCP connection 130_{A}. In an embodiment in which the data object is propagated from a data repository accessible only to the active server 110_{A}, it is assumed that a similarly segmented version of the data object also is available to backup server 110_{B}, such that backup server 110_{B} may continue providing segments of the data object to client 120 via TCP connection 130 when active server 110_{A} fails (i.e., so that no portion of the data object fails to be accounted for during transition of the TCP connection from the active server 110_{A} to the backup server 110_{B} when the active server 110_{A} fails).

The active server 110_{A}, while active, continues to retrieve segments of the data object to be provided to client 120 and to propagate the retrieved segments of the data object toward client 120 using the TCP connection 130_{A}.

As depicted at step 240 of FIG. 2, the active server 110_{A} provides information to the backup server 110_{B} for use by the backup server in maintaining the TCP connection 130, and the associated active data connection supported by the TCP connection 130, when active server 110_{A} fails. The information provided from the active server 110_{A} to the backup server 110_{B} includes the TCP connection information and the data object transfer information.

It is noted that, although primarily depicted and described with respect to an embodiment in which active server 110_{A} provides the TCP connection information and the data object transfer information to backup server 110_{B} together or at least contemporaneously, active server 110_{A} may provide such information to backup server 110_{B} separately (e.g., where the respective portions of the information may be sent at any suitable time(s)).

Similarly, it is noted that although primarily depicted and described with respect to an embodiment in which active server 110_{A} provides the TCP connection information and the data object transfer information to backup server 110_{B} after the transfer of the data object from active server 110_{A} to client 120 has already begun, the active server 110_{A} may provide some or all of the information to backup server 110_{B} prior to initiation of the transfer of the data object from active server 110_{A} to client 120.

It is further noted that various combinations of such embodiments also may be supported.

In one embodiment, for example, the TCP connection information is sent following completion of the three-way handshake of step 210 and the data object transfer information is sent following completion of the data object transfer negotiation of step 220.

In this manner, the TCP connection information and the data object transfer information may be provided from active server 110_{A} to backup server 110_{B} at any suitable time(s), so long as the information is available to backup server 110_{B} when active server 110_{A} fails.

The TCP connection information and data object transfer information may be provided from the active server 110_{A} to the backup server 110_{B} in any suitable form (e.g., using any suitable type(s) and/or number(s) of messages from the active server 110_{A} to the backup server 110_{B}).

The backup server 110_{B} receives and stores the TCP connection information and the data object transfer information. The backup server 110_{B} stores the TCP connection information and data object transfer information for use in maintaining the TCP connection 130 (including the active data transfer for transferring the data object via TCP connection 130) when active server 110_{A} fails. The backup server 110_{B} may store the TCP connection information for TCP connection 130_{A} until receiving an indication from active server 110_{A} that the TCP connection 130_{A} has been terminated. Similarly, the backup server 110_{B} may store the data object transfer information until receiving an indication from active server 110_{A} that the TCP connection 130_{A} has been terminated or that the transfer of the data object via the TCP connection is terminated.

As depicted at step 250 of FIG. 2, the active server 110_{A} fails and the backup server 110_{B} detects the failure of the active server 110_{A}.

The backup server 110_{B} may detect the failure of active server 110_{A} in any suitable manner. In one embodiment, for example, the backup server 110_{B} monitors active server 110_{A} for detecting the failure of active server 110_{A}. For example, backup server 110_{B} may use a heartbeat process for monitoring the status of active server 110_{A} and, thus, for detecting failure of active server 110_{A}. In one embodiment, for example, the backup server 110_{B} is notified of the failure of the active server 110_{A} (e.g., from one or more other network elements monitoring active server 110_{A} for failure).

It is noted that the time taken for the backup server 110_{B} to detect failure of the active server 110_{A} and assume responsibility for the TCP connection 130 must be less than the round-trip-time (RTT) of the TCP connection 130, in order to enable backup server 110_{B} to receive the TCP acknowledgement message from the client 120.

The backup server 110_{B}, upon detecting a failure of the active server 110_{A}, performs a process for maintaining the TCP connection 130 with client 120 (illustratively, via TCP connection 130_{B} between backup server 110_{B} and client 120), which is depicted and described with respect to steps 260, 270, and 280 of FIG. 2.

As depicted at step 260 of FIG. 2, the backup server 110_{B} receives a TCP acknowledgment message from client 130.

The TCP acknowledgment message includes TCP connection information identifying the TCP connection with which the TCP connection acknowledgement message is associated. As described herein, the TCP connection information of the received TCP acknowledgment message may include source IP address, source port, destination IP address, and destination port for the TCP connection, as well as TCP options for the TCP connection. This enables the backup server 110_{B} to distinguish between TCP acknowledgment messages of multiple different TCP connections for which backup server 110_{B} may be providing the resilient data transfer capability.

The TCP acknowledgment message includes a current TCP sequence number for the TCP connection 130, which acknowledges receipt by the client 120 of all prior bytes sent from the active server 110_{A} to the client 120 before active server 110_{A} failed.

The TCP acknowledgment message may be provided to the backup server 110_{B} in any suitable manner. In one embodiment, a mechanism is provided, within communication network 101, for ensuring that a TCP acknowledgement message transmitted by the client 120 and intended for the active server 110_{A} is redirected to the backup server 110_{B} when active server 110_{A} fails (e.g., using one or more load balancing elements associated with the servers 110, using one or more redirector elements associated with the servers 110, and the like, as well as various combinations thereof). In one embodiment, backup server 110_{B}, upon detecting a failure of the active server 110_{A}, may be configured to monitor for the TCP acknowledgment message from the client 120, or may simply be configured such that upon arrival of the TCP acknowledgment message the backup server 110_{B} processes the TCP acknowledgment message and identifies the TCP acknowledgment message as being associated with TCP connection 130. In any event, after failure of active server 110_{A}, backup server 110_{B} receives the TCP acknowledgment message, identifies the TCP acknowledgment message as being associated with TCP connection 130, and determines the current TCP sequence number for the TCP connection 130 from the TCP acknowledgment message.

As depicted at step 270 of FIG. 2, the backup server 110_{B} then initiates a process to maintain the TCP connection 130, and the associated active data transfer of the data object being transferred via the TCP connection 130, with the client 120.

The backup server 110_{B} extracts TCP connection information from the TCP acknowledgment message received from client 120. The backup server 110_{B} uses the TCP connection information from the TCP acknowledgment message to retrieve the data object transfer information that is associated with the data object transfer active on TCP connection 130 at the time of the failure of active server 110_{A}. As described hereinabove, the backup server 110_{B} stores information for the TCP connection 130_{A} such that the TCP connection information for TCP connection 130_{A} and the data object transfer information for the data object transfer active on TCP connection 130 are associated with each other. As a result, backup server 110_{B} may use the TCP connection information that is extracted from the TCP acknowledgment message as a key into memory that is storing TCP connection information and data object transfer information for TCP connections for which the backup server 110_{B} is responsible. In this manner, when backup server 110_{B} identifies stored TCP connection information matching the TCP connection information that is extracted from the TCP acknowledgment message (i.e., identifies the stored information that is associated with TCP connection 130 for which the TCP acknowledgment message was received), the backup server 110_{B} may then retrieve the stored data object transfer information that is associated with the TCP connection information.

The backup server 110_{B} also extracts the current TCP sequence number of the data object transfer from the received TCP acknowledgment message.

The backup server 110_{B} uses the retrieved data object transfer information associated with TCP connection 130 (e.g., data object identifier of the data object and TCP Sequence Number representing the first byte of the data object transferred via the TCP connection 130), in conjunction with the current TCP sequence number retrieved from the TCP acknowledgment message, to continue transferring the data object to the client 120 beginning with the next byte of data expected by the client 120.

The backup server 110_{B} uses the retrieved data object identifier of the data object to identify the data object being transferred via TCP connection 130 and, thus, to retrieve portions of that data object to be transferred from backup server 110_{B} to client 120 via the TCP connection 130.

The backup server 110_{B} uses the TCP Sequence Number representing the first byte of the data object transferred via the TCP connection 130 (as determined from the stored data object information) and the current TCP sequence number (retrieved from the TCP acknowledgment message) to determine a next byte of the data object to be transferred from backup server 110_{B} to client 120 via the TCP connection 130. In one embodiment, the next byte of data to be transferred from backup server 110_{B} to client 120 via the TCP connection 130 is determined as next-byte=[(current TCP sequence number)−(TCP Sequence Number representing the first byte of the data object transferred via the TCP connection 130)].

The backup server 110_{B}, given the data object identifier and the next byte of the data object to be transferred, begins retrieving the identified portion of the data object for transfer to client 120 (e.g., retrieving the next byte of the data object and subsequent bytes of the data object for transfer to client 120 via TCP connection 130).

As depicted at step 280 of FIG. 2, the backup server 110_{B} begins transferring the data object toward the client 120 via TCP connection 130_{B} (which is a continuation of transfer of the data object toward client 120 via TCP connection 130).

In this manner, backup server 110_{B} has assumed responsibility for transport of the data object to client 120 via TCP connection 130 such that the failure of active server 110_{A} does not impact the ability of the client 120 to receive the data object (e.g., backup server 110_{B} is able to continue transferring the data object to the client 120 beginning with the next byte of data expected by the client 120, thereby preventing any loss of data of the data object even when the active server 110_{A} has failed during the data object transfer).

As depicted in FIG. 2, an example is provided with respect to values that are included within the TCP data and TCP acknowledgment messages exchanged within the context of FIG. 2.

As depicted in FIG. 2, the final segment of the data object sent from active server 110_{A} to client 120 via TCP connection 130_{A} before failure of the active server 110_{A} includes the following information: Sequence Number: X; ACK: Y; and Length: Z.

As depicted in FIG. 2, based on the final segment of the data object sent from active server 110_{A} to client 120 via TCP connection 130_{A} before failure of the active server 110_{A}, the TCP acknowledgment message includes the following information: Sequence Number: Y; ACK: A (which is equivalent to X+Z+1); and Length: 0.

As a result, the backup server 110_{B} computes the next byte of data to be transferred from backup server 110_{B} to client 120 via the TCP connection 130 as follows: [(Δ−ω)]. As depicted in FIG. 2, the first segment of the data object sent from backup server 110_{B} to client 120 via TCP connection 130_{B} after failure of the active server 110_{A} includes the following information: Sequence Number: A; ACK: Y; and Length: Z.

It is noted that the values of this example are merely exemplary, and that any suitable values may be used.

It is noted that, although omitted for purposes of clarity, situations may arise in which the TCP sequence number of a TCP connection experiences a wraparound condition. In this case, having the TCP Sequence Number that represents the first byte of the data object transferred via the TCP connection 130_{A} (denoted herein as w) may not be sufficient to determine the next byte of the data object to be transferred. Rather, in this case, the backup server 110_{B} also may use information indicative of the number of times the TCP Sequence Number has experienced a wraparound condition. This wraparound condition counter for the TCP Sequence Number may be provided from the active server 110_{A} to the backup server 110_{B} in any suitable manner and, similarly, may be maintained by the backup server 110_{B} in any suitable manner. In one embodiment, for example, the active server 110_{A} provides the wraparound condition information to the backup server 110_{B} via a notification from the active server to the backup server 110_{B} each time the wraparound condition occurs. In one embodiment, for example, the backup server 110B maintains the wraparound condition information as part of the data object transfer information maintained at backup server 110_{B} for the TCP connection 130.

It is noted that, although primarily depicted and described with respect to an embodiment in which a single data object transfer is performed via the TCP connection 130, any suitable number of data object transfers may be supported by the TCP connection 130. For example, the data object transfer described with respect to FIG. 1 may be preceded by and/or followed by any suitable number of other data object transfers. As a result, for each data object transfer via TCP connection 130, the active server 110_{A} determines the associated data object transfer information and provides the data object transfer information to the backup server 110_{B}. Furthermore, for each data object transfer made via TCP connection 130, the active server 110_{A} may or may not provide the associated TCP connection information for the TCP connection 130 to backup server 110_{B}. In one embodiment, for example, the active server 110_{A} may only send the TCP connection information once, in conjunction with establishment of the TCP connection 130 and/or with the first data object transfer made via TCP connection 130, so as to avoid sending the TCP connection information to backup server 110_{B} multiple times for each data object transfer in the case of multiple data object transfers. In one embodiment, for example, active server 110_{A} may resend the TCP connection information to backup server 110_{B} each time data object information is sent from the active server 110_{A} to the backup server 110_{B}, so as to avoid a need for the active server to keep track of which data object transfer is the first that is made via the TCP connection 130 and/or to protect against situations in which a portion of the TCP connection information of the TCP connection 130 may change across different data object transfers made via the TCP connection 130. In one embodiment, a combination of such techniques may be used (e.g., where the TCP connection information for TCP connection 130 is provided from active server 110_{A} to backup server 110_{B} only when the TCP connection information for the TCP connection changes).

In one embodiment, upon recovery of the active server 110_{A}, the TCP connection 130 is maintained on the backup server 110_{B}, rather than being transitioned back to the active server 110_{A}. In one such embodiment, the active server 110_{B} may then operate in the role of a backup server for backup server 110_{B} (e.g., such that if backup server 110_{B} fails, the TCP connection 130 can be transitioned back to the active server 110_{A} without loss of the TCP connection 130).

In one embodiment, upon recovery of the active server 110_{A}, the TCP connection 130 is transitioned from the backup server 110_{B} back to the active server 110_{A}.

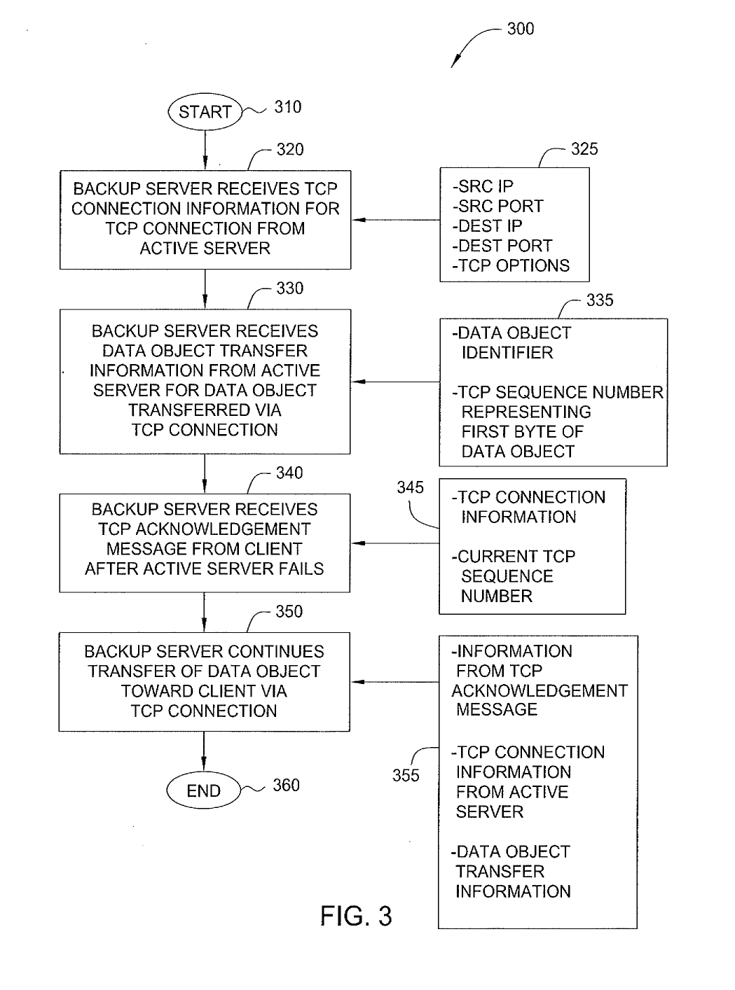

FIG. 3 depicts a method according to one embodiment of the resilient data transfer capability. The method 300 is executed within an environment including active and backup servers, where a TCP connection is initially established between the active server and a client for streaming a data object to the client. The method 300 is executed by the backup server for assuming control of the TCP connection when the active server fails, thereby providing resilient streaming of the data object to the client via the TCP connection.

At step 310, method 300 begins.

At step 320, the backup server receives TCP connection information for the TCP connection from the active server. As indicated at box 325, the TCP connection information includes information such as source IP address, source port, destination IP address, destination port, TCP options, and the like.

At step 330, the backup server receives data object transfer information, associated with transfer of a data object via the TCP connection, from the active server. As indicated at box 335, the data object transfer information includes a data object identifier of the data object, a TCP Sequence Number that represents the first byte of the data object transferred via the TCP connection, and the like.

At step 340, the backup server receives a TCP acknowledgment message from the client after the active server fails. As indicated at box 345, the TCP acknowledgment message includes TCP connection information for the TCP connection for which the TCP acknowledgment message is received, a current TCP sequence number for the TCP connection, and the like.

At step 350, the backup server continues the data object transfer to the client via the TCP connection using the TCP connection information, the data object transfer information, and the current TCP sequence number. As indicated at box 355, the backup server continues the data object transfer to the client using information from the TCP acknowledge message, the TCP connection information, and the data object transfer information. In one embodiment, the backup server continues the data object transfer to the client via the TCP connection as depicted and described with respect to steps 260, 270, and 280 of FIG. 2.

At step 360, method 300 ends.

Although omitted for purposes of clarity, it is noted that backup server continues to stream the data object to the client until a condition is satisfied (e.g., until the data connection terminates normally or abnormally, until the TCP connection terminates normally or abnormally, until the active server recovers from the failure and the TCP connection is transferred back to the active server, and the like).

Although primarily depicted and described herein with respect to embodiments in which the backup server maintains the TCP connection to the client when the active server fails, it is noted that backup server may be configured to maintain the TCP connection to the client in response to any condition which would otherwise result in disruption and/or loss of the TCP connection.

Although primarily depicted and described herein with respect to embodiments in which propagation of the data object to the client is tracked and controlled in terms of bytes of the data object, it is noted that propagation of the data object to the client may be tracked and controlled in any other suitable sizes of the portions of the data object being propagated to the client. Accordingly, in at least some embodiments, references herein to bytes of the data object may be read more generally as being references to portions of the data object, where each portion of the data object may include any suitable amount of data.

The resilient data transfer capability significantly reduces the amount of TCP state information that needs to be synchronized between active and backup servers, obviating the need for continuous synchronization of TCP state and/or TCP sequence numbers between active and backup servers.

The resilient data transfer capability enables multiple active servers to be protected using a single backup server (e.g., because of the reduction of synchronization between servers), thereby obviating a need for each active server to have a dedicated backup server.

The resilient data transfer capability provides various other advantages which have been described herein and which will be recognized from the depiction and description of the resilient data transfer capability provided herein.

Although primarily depicted and described herein with respect to embodiments in which the resilient data transfer capability is provided for a TCP connection between a server and a client, it is noted that embodiments of the resilient data transfer capability may be used to provide resiliency for TCP connections between other types of devices. As such, the terms server and client may be referred to more generally, e.g., data source and data destination, as source computer and destination computer, or using any other suitable terms. Furthermore, references to such devices also may be considered to be references to the programs, running on the devices, for which the TCP connection is used (e.g., application programs or any other suitable type(s) of programs which may utilize a TCP connection for transfer of data).

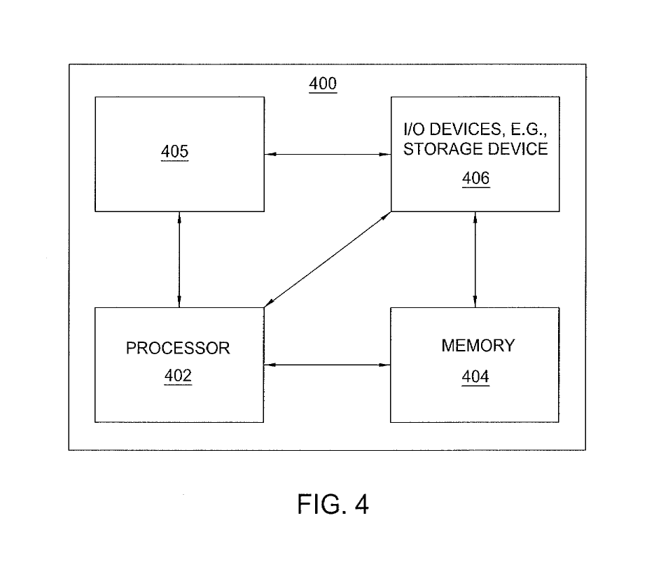

FIG. 4 depicts a high-level block diagram of a computer suitable for use in performing functions described herein.

As depicted in FIG. 4, computer 400 includes a processor element 402 (e.g., a central processing unit (CPU) and/or other suitable processor(s)) and a memory 404 (e.g., random access memory (RAM), read only memory (ROM), and the like). The computer 400 also may include a cooperating module/process 405 and/or various input/output devices 406 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software and/or hardware, e.g., using a general purpose computer, one or more application specific integrated circuits (ASIC), and/or any other hardware equivalents.

In one embodiment, the cooperating process 405 can be loaded into memory 404 and executed by processor 402 to implement the functions as discussed herein. In this embodiment, the cooperating process 405 (including associated data structures) can be stored on a computer readable storage medium, e.g., RAM memory, magnetic or optical drive or diskette, and the like.

It will be appreciated that computer 400 depicted in FIG. 4 provides a general architecture and functionality suitable for implementing functional elements described herein and/or portions of functional elements described herein. For example, the computer 400 provides a general architecture and functionality suitable for implementing one or more of the active server 110_{A}, a portion of the active server 110_{A}, the backup server 110_{B}, a portion of the backup server 110_{B}, and the client 120.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus for maintaining a transfer of a data object to a client via a Transmission Control Protocol (TCP) connection using a backup server when an active server fails, the apparatus comprising:
a processor and a memory, the processor configured to:
receive, at the backup server, TCP connection information associated with the TCP connection between the active server and the client and data object transfer information associated with a data object transfer supported using the TCP connection between the active server and the client; and
when the active server fails:
receive, at the backup server, a TCP acknowledgment message of the client comprising a current TCP sequence number for the data object transfer via the TCP connection between the active server and the client; and
continue the data object transfer from the backup server to the client via the TCP connection using the TCP connection information, the data object transfer information, and the current TCP sequence number.

2. The apparatus of claim 1, wherein the TCP connection information comprises a source Internet Protocol (IP) address of the active server, a source port of the server, a destination IP address of the client, a destination port of the client, and TCP options information,

3. The apparatus of claim 1, wherein the TCP connection information is received from the active server when the TCP connection is established.

4. The apparatus of claim 1, wherein the data object transfer information comprises an identifier of the data object and a TCP Sequence Number representing a first byte of the data object transferred via the TCP connection.

5. The apparatus of claim 1, wherein the data object transfer information is received from the active server when a data object transfer negotiation between the active server and the client is complete.

6. The apparatus of claim 1, wherein the processor is configured to monitor the active server for detecting failure of the active server.

7. The apparatus of claim 1, wherein the processor is configured to, when the active server fails, monitor for the TCP acknowledgment message from the client.

8. The apparatus of claim 1, wherein the processor is configured to associate the data object transfer information with the TCP connection information.

9. The apparatus of claim 1, further comprising:
a memory configured to store the TCP connection information and the data object transfer information, wherein the data object transfer information is associated with the TCP connection information.

10. The apparatus of claim 1, wherein the processor is configured to continue the data object transfer by:
determining, from the TCP acknowledgment message, TCP connection information associated with the TCP connection for which the TCP acknowledgment message is received;
retrieving the data object transfer information for the data object transfer by matching at least a portion of the TCP connection information determined from the TCP acknowledgement message to at least a portion of the TCP connection information received at the backup server from the active server; and
continuing the data object transfer from the backup server to the client using the retrieved data object transfer information and the current TCP sequence number.

11. The apparatus of claim 10, wherein the data object transfer information comprises an identifier of the data object and a TCP Sequence Number representing a first byte of the data object transferred via the TCP connection, wherein the processor is configured to continue the data object transfer from the backup server to the client using the retrieved data object transfer information and the current TCP sequence number by:
determining, using the data object transfer information and the current TCP sequence number, a next byte of the data object to be transferred from the backup server to the client via the TCP connection;
initiating transfer of the data object from the backup server toward the client using the data object identifier and the next byte of the data object to be transferred from the backup server to the client.

12. The apparatus of claim 11, wherein the next byte of the data object to be transferred from the backup server to the client via the TCP connection is determined as:
[(the current TCP sequence number)−(the TCP Sequence Number representing the first byte of the data object transferred via the TCP connection)].

13. The apparatus of claim 11, wherein initiating transfer of the data object from the backup server toward the client using the data object identifier and the next byte of the data object to be transferred from the backup server to the client comprises:
retrieving the next byte of the data object to be transferred from the backup server to the client using the data object identifier of the data object and an identifier of the next byte of the data object to be transferred from the backup server to the client; and
propagating the next byte of the data object from the backup server toward the client.

14. A method for maintaining a transfer of a data object to a client via a Transmission Control Protocol (TCP) connection using a backup server when an active server fails, the method comprising:
receiving, at the backup server, TCP connection information associated with the TCP connection between the active server and the client and data object transfer information associated with a data object transfer supported using the TCP connection between the active server and the client; and
when the active server fails:
receiving, at the backup server, a TCP acknowledgment message of the client comprising a current TCP sequence number for the data object transfer via the TCP connection between the active server and the client; and
continuing the data object transfer from the backup server to the client via the TCP connection using the TCP connection information, the data object transfer information, and the current TCP sequence number.

15. An apparatus for maintaining a transfer of a data object to a client via a Transmission Control Protocol (TCP) connection using a backup server when an active server fails, the apparatus comprising:
a processor and a memory, the processor configured to:
receive, at the backup server, a TCP acknowledgment message of the client comprising a current TCP sequence number for the data object transfer via the TCP connection between the active server and the client;
determine, based on the current TCP sequence number and a TCP sequence number representing a first portion of the data object transferred from the active server to the client via the TCP connection, a next portion of the data object to be transferred from the backup server to the client; and
propagate the next portion of the data object from the backup server toward the client via the TCP connection.

16. The apparatus of claim 15, wherein the processor is configured to determine the next portion of the data object to be transferred from the backup server to the client as:
[(the current TCP sequence number)−(the TCP Sequence Number representing the first portion of the data object transferred via the TCP connection)].

17. The apparatus of claim 15, wherein the processor is configured to:
receive, at the backup server, TCP connection information associated with the TCP connection established between the active server and the client and data object transfer information associated with a data object transfer supported using the TCP connection, wherein the data object transfer information comprises the TCP sequence number representing the first portion of the data object transferred from the active server to the client via the TCP connection.

18. The apparatus of claim 17, wherein the processor is configured to propagate the next portion of the data object from the backup server toward the client via the TCP connection by:
determining, from the TCP acknowledgment message, TCP connection information associated with the TCP connection for which the TCP acknowledgment message is received;
retrieving the data object transfer information for the data object transfer by matching at least a portion of the TCP connection information determined from the TCP acknowledgement message to at least a portion of the TCP connection information received at the backup server from the active server;
determining, from the data object transfer information, a data object identifier of the data object;
retrieving the next portion of the data object to be transferred from the backup server to the client using the data object identifier of the data object and the identifier of the next portion of the data object to be transferred from the backup server to the client; and
propagating the retrieved next portion of the data object from the backup server toward the client via the TCP connection.

19. The apparatus of claim 15, wherein the TCP acknowledgment message is directed by the client to the active server and is received by the backup server after the active server fails.

20. A method for maintaining a transfer of a data object to a client via a Transmission Control Protocol (TCP) connection using a backup server when an active server fails, the method comprising:
receiving, at the backup server, a TCP acknowledgment message of the client comprising a current TCP sequence number for the data object transfer via the TCP connection between the active server and the client;
determining, based on the current TCP sequence number and a TCP sequence number representing a first portion of the data object transferred from the active server to the client via the TCP connection, a next portion of the data object to be transferred from the backup server to the client; and
propagating the next portion of the data object from the backup server toward the client via the TCP connection.
